(19) United States
(12) Patent Application Publication
(10) Pub. No.: US 2017/0212061 A1
(43) Pub. Date: Jul. 27, 2017

(54) METHODS OF DETECTING FLOW LINE DEPOSITS USING GAMMA RAY DENSITOMETRY

(71) Applicant: SHELL OIL COMPANY, Houston, TX (US)

(72) Inventors: Rajneesh VARMA, Houston, TX (US); Gregory John HATTON, Houston, TX (US); Karthik RAMANATHAN, Houston, TX (US)

(21) Appl. No.: 15/326,951

(22) PCT Filed: Jul. 20, 2015
(86) PCT No.: PCT/US2015/041141

§ 371 Date: Jan. 17, 2017

Related U.S. Application Data
(60) Provisional application No. 62/027,574, filed on Jul. 22, 2014.

(51) Int. Cl. G01N 23/10; G01B 15/02

(52) U.S. Cl. CPC G01N 23/10; G01B 15/025; G01N 2223/101; G01N 2223/633

(57) ABSTRACT

A method of measuring a flow line deposit comprising: providing a pipe comprising the flow line deposit; measuring unattenuated photon counts across the pipe; and analyzing the measured unattenuated photon counts to determine the thickness of the flow line deposit and associated systems.

### CROSS-REFERENCE TO RELATED APPLICATIONS

This application claims the benefit of U.S. Provisional Application No. 62/027,574, filed Jul. 22, 2014, which is incorporated herein by reference.

### BACKGROUND

The present disclosure relates generally to methods for detecting flow line deposits using gamma ray densitometry. More specifically, in certain embodiments, the present disclosure relates to methods for measuring the thickness of flow line deposits using non-invasive gamma ray densitometry and associated systems.

Deposits of substances from production streams in flow lines are a common occurrence in the oil and gas industry. These deposits, if unattended, build over a period of time and reduce the effective cross sectional area available for the flow, thereby increasing pressure drops or reducing the flow of the hydrocarbons. In extreme cases, the deposits may build to fill the lumen leading to complete blockage of the flow line and thereby impacting the availability of hydrocarbons. The blocked flow lines are particularly hard to remediate and may need to be replaced if not remediated. The remediation may get more complex in subsea environments where accessibility may be limited or interventions may be expensive, and replacement costs may be higher than at onshore location.

Advance, or online knowledge, of deposit formation can help the remediation strategies and prevent complete blockage of flow lines. Current or real time information about the extent of deposits can be used to develop an optimal pigging strategy which effectively clears deposits, while it is cost efficient in terms of application frequency. Since the deposits may form on the inner walls of flow lines which are typically insulated, or in pipe-in-pipe configuration with the annular space filled with insulation material, it's hard to inspect the pipes and quantify deposit formation. Other sensors, such as pressure transducers or temperature probes, are invasive and are often inserted at the ends of the flow lines. It may not be practical to cover every running foot of the flow line with these invasive sensors.

It is desirable to develop a non-invasive method to determine the presence as well as the thickness of the deposit within the pipelines.

### SUMMARY

The present disclosure relates generally to methods for detecting flow line deposits using gamma ray densitometry. More specifically, in certain embodiments, the present disclosure relates to methods for measuring the thickness of flow line deposits using non-invasive gamma ray densitometry and associated systems.

In one embodiment, the present disclosure provides a method of measuring a flow line deposit comprising: providing a pipe comprising the flow line deposit; measuring unattenuated photon counts across the pipe; and analyzing the measured unattenuated photon counts to determine the thickness of the flow line deposit.

In another embodiment, the present disclosure provides a method of measuring a flow line deposit comprising: providing a pipe comprising the flow line deposit; measuring unattenuated photon counts across the pipe; and calculating the thickness of the flow line deposit.

In another embodiment, the present disclosure provides a system comprising: a pipe comprising a flow line deposit and a densitometer.

### BRIEF DESCRIPTION OF THE DRAWINGS

A more complete and thorough understanding of the present embodiments and advantages thereof may be acquired by referring to the following description taken in conjunction with the accompanying drawings.

FIG. 1 is an illustration of a photon detection system.

FIG. 2 is an illustration of a photon detection system.

FIG. 3 is a chart depicting unattenuated photon counts along numerous chords.

FIG. 4 is a chart depicting corrected attenuation counts along numerous chords.

FIG. 5 is an illustration of a pipe system.

FIG. 6 is a chart depicting unattenuated photon counts along numerous chords.

FIG. 7 is a chart depicting unattenuated photon counts along numerous chords.

The features and advantages of the present disclosure will be readily apparent to those skilled in the art. While numerous changes may be made by those skilled in the art, such changes are within the spirit of the disclosure.

### DETAILED DESCRIPTION

The description that follows includes exemplary apparatuses, methods, techniques, and/or instruction sequences that embody techniques of the inventive subject matter. However, it is understood that the described embodiments may be practiced without these specific details.

The present disclosure relates generally to methods for detecting flow line deposits using gamma ray densitometry. More specifically, in certain embodiments, the present disclosure relates to methods for measuring the thickness of flow line deposits using non-invasive gamma ray densitometry and associated systems.

Some desirable attributes of the methods discussed herein are that they are non-invasive methods that are able to more accurately determine the presence and thickness of the deposit and blockages within the pipelines than conventional methods. In certain embodiments, the methods described herein, may be used to non-invasively detect solids and solids that have liquid and gas occluded, which deposit on the inner walls of flow lines that transport hydrocarbons such as gas and oils.

The present invention involves the development of a methodology for gathering gamma ray or x-ray densitometry data of hydrocarbon flow lines. The methodology may include gathering densitometer data and multiphase flow data and processing that data to determine the presence of solid deposits on the inner pipeline wall and blockages in the core or lumen of the flow line.

In one embodiment, the present disclosure provides a method comprising: providing a pipe system comprising a pipe with a flow line deposit; measuring unattenuated photon counts across the pipe; and determining the thickness of the flow line deposit.

In certain embodiments, the pipe may be a flow line used to transport hydrocarbons. In certain embodiments, the pipe may be an onshore flow line or a subsea flow line. In certain embodiments, hydrocarbons may be present in the flow line in a gas phase, a liquid phase, or in a multiphase. In certain embodiments, the flow regime within the pipe may be stratified, wavy, slug, churn, or misty. In certain embodiments, the pipe may be an insulated pipe, a bare pipe, or a pipe-in-pipe system.

In certain embodiments, measuring unattenuated photon counts may comprise generating incident photon counts on a first side of the pipe and detecting photon counts on a second side of the pipe. In certain embodiments, the measurements may be made in a specific manner such that it utilizes characteristics of underling multiphase flow dynamics in the flow line. In certain embodiments, the incident photon counts may be generated by an X-ray source or a gamma ray source. In certain embodiments, the generation of incident photon counts and the measurement of the unattenuated photon counts may be accomplished utilizing densitometer.

In certain embodiments, the densitometer may comprise a source and a detector array. In certain embodiments, the source may be a small radioactive object that emits gamma or X-ray photons. In certain embodiments, the detector array may comprise a single detector or multiple detectors which sense or measure photons in a quantitative manner. The detector arrays may be positioned around the flow line in a number of ways, some of which are described below.

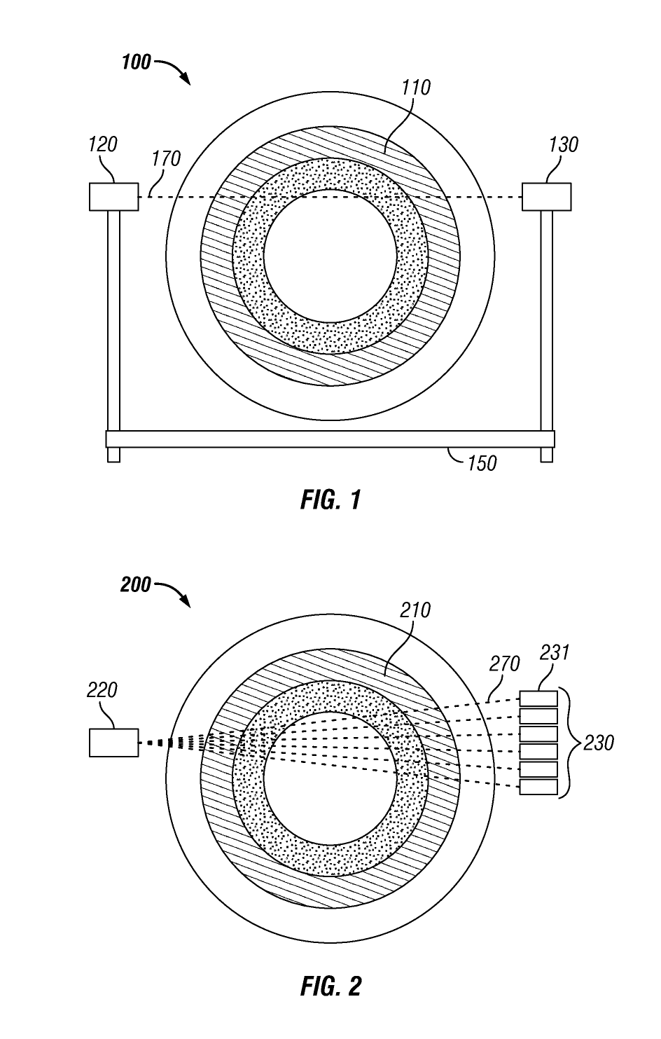

In certain embodiments, a single source and detector can be used in a parallel beam arrangement as shown in FIG. 1. Referring now to FIG. 1, FIG. 1 illustrates a photon detection system 100 comprising a flow line 110, a source 120, and a detector 130. As can be seen in FIG. 1, source 120 and detector 130 may be placed along a line such that photons emitted from source 120 are in the line of sight of detector 130 along a chord 170. In certain embodiments, a movable arm 150 may be attached to source 120 and detector 130 allowing the line of sight to move down up and down the cross section of flow line 110 allowing the measurement of unattenuated photon counts at numerous chords 170 of varying distances from the center of the flow line 110.

In certain embodiments, a single source and an array of detectors can be used in a fan beam arrangement as shown in FIG. 2. Referring now to FIG. 2, FIG. 2 illustrates a photon detection system 200 comprising a flow line 210, a source 220, and a detector array 230. Detector array 230 may comprise a plurality of detectors 231. As can be seen in FIG. 2, source 220 and a detector array 230 may be placed along a line such that photons emitted from source 220 is in the line of a single detector 231 of detector array 230 along a chord 270. In certain embodiments, source 220 and/or detector array 230 may be rotated along an axis that lies in the center of the plane, allowing photons to be emitted in the line of sight of each detector 231 in detector array 230 allowing the measurement of unattenuated photon counts along numerous chords 270 of varying orientation and distances from the center of the flow line 210.

In certain embodiments, the densitometers may be positioned about a first location of the pipe and be utilized to generate and measure photon counts that traverse across a cross section of the pipe along a first chord. The unattenuated photon counts may be measured by the detector along this first chord and the ratio of attenuated to incident photon counts may be calculated. The distance of the first chord from a reference point of the pipe may also be measured and recorded. In certain embodiments, multiple measurements may be taken across the pipe along an initial chord. After the measurements are completed along the initial chord, the densitometer may be re-positioned to measure the attenuation of gamma ray photon counts along other chords.

In certain embodiments, for example in the parallel beam embodiment, the source and detector line may be relocated in an orientation in the same plane such that is parallel to the initial cord measurements, thereby creating a second cord. The position of other chords relative to the first chord may also be measured and recorded.

In certain embodiments, for example in the fan beam embodiment, the source and the detector array may be relocated, or re-oriented, with the center of the flow line as an axis. This way a new set of cords or lines may be created between the source and the individual detectors of the array. The photon count measurements may be made along the new cords and the data may be recorded.

In certain embodiments, for example in the fan beam embodiments and the parallel beam embodiments, the rotation and repositioning of the detector and the source can be made by rotating the source and detector. The densitometer may be repositioned along the length of the flow line to repeat the process.

Once data has been obtained from a sufficient number of chords of varying distances from the reference point, at a given location of the flow line, that data may then be processed to determine the thickness of a deposit on the pipe. The number of chords sufficient may depend one the size of the pipe and the number of layers of the pipe.

In certain embodiments, determining the thickness of the deposit on the pipe may comprise analyzing the measured unattenuated photon counts to determine the thickness of the flow line deposit.

In certain embodiments, analyzing the measured unattenuated photon counts may comprise plotting the measured unattenuated photon counts across the pipe as a function of distance from the reference point and analyzing that plot to determine the thickness of the deposit on the pipe. As used herein, height, h, is referred to as the distance of the chord measurement from the reference point of the cross section of the pipe.

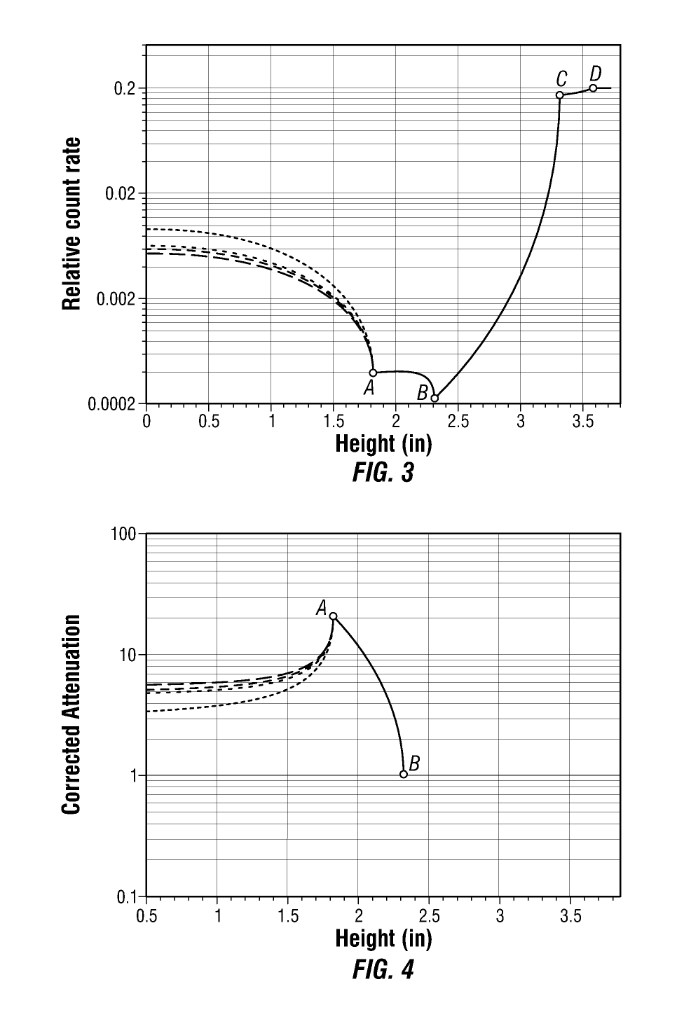

An example of such a plot generated by this method is shown in FIG. 3. As can be seen by FIG. 3, the unattenuated photon counts along each chord vary as a function of h. At an initial height of 0, the count rates for a given section of pipe are shown to be slightly variable. As the height increases, the variance of these counts rates decreases to a point where there is a first conversion (Point A). Point A represents the height from the center of the pipe where the inner layer of the deposit is. As can be seen in FIG. 3, point A occurs at a height of 1.8 inches. As the height further increases, the unattenuated photon count decreases until there is a local minimum (Point B). Point B represents the height from the center of the pipe where the deposit ends. As can be seen in FIG. 3, point B occurs at a height of 2.3 inches. This point occurs at a height that is equal to the inner radius of the pipe. The difference in height from Point B to Point A represents the thickness of the deposit. As can be seen in FIG. 3, the thickness of the deposit is 0.5 inches. As the height further increases, the unattenuated photon count increases until a sharp point is reached (Point C). Point C represents the height from the center of the pipe where the pipe ends. As can be seen in FIG. 3, point C occurs at a height of 3.3 inches. This point occurs at height that is equal to the outer radius of the pipe. In embodiments where the pipe comprises an outer coating, as the height further increases, the unattenuated photon count increases until another sharp point is reached (Point D). Point D represents the height from the center of the pipe where the insulation ends. As can be seen in FIG. 3, point D occurs at a height of 3.6 inches. This point occurs at height that is equal to the outer radius of the pipes insulation.

In other embodiments, analyzing the measured unattenuated photon counts may comprise plotting a corrected attenuation count as a function of h and analyzing that plot to determine the thickness of the deposit on the pipe. In this embodiment, the corrected attenuation count may be obtained subtracting the measured unattenuated photon counts from the incident photon counts and then dividing that number by measured attenuation counts of an empty pipe at each chord.

An example of such a plot generated by this method is shown in FIG. 4. As can be seen by FIG. 4, the corrected attenuation count varies as a function of h. At an initial height of 0, the count rates for a given section of pipe are shown to be slightly variable. As the height increases, the variance of these counts rates decreases to a point where there is a first conversion (Point A). Point A represents the height from the center of the pipe where the inner layer of the deposit is. As can be seen in FIG. 4, point A occurs at a height of 1.8 inches. As the height further increases, the attenuation increases until there is a local minimum (Point B). Point B represents the height from the center of the pipe where the deposit ends. As can be seen in FIG. 4, point B occurs at a height of 2.3 inches. This point occurs at a height that is equal to the inner radius of the pipe. The difference in height from Point B to Point A represents the thickness of the deposit. As can be seen in FIG. 4, the thickness of the deposit is 0.5 inches. As the height further increases, the corrected attenuation remains constant.

In other embodiments, determining the thickness of a deposit may comprise calculating the thickness of the deposit. In certain embodiments, the thickness of the deposit may be calculated at each chord length utilizing the following equation:

$${l}_{deposit} = \frac{- ( \begin{matrix}{μ}_{Water} {l}_{Water} + {μ}_{insulation} {l}_{insulation} + \\ {μ}_{wall} {l}_{wall} + {μ}_{stream} R 1 + ln ( \frac{I}{{I}_{o}} )\end{matrix} )}{{μ}_{deposit} - {μ}_{stream}} ,$$

where l_{deposit} is the chord length of the deposit, μ_{Water} is the attenuation constant of water, l_{Water} is the chord length of the water at a given height, μᵢₙₛᵤₗₐₜᵢₒₙ is the attenuation constant of the insulation, lᵢₙₛᵤₗₐₜᵢₒₙ is the chord length of the insulation at a given height, μₛₜᵣₑₐₘ is the attenuation constant of the fluid within the pipe, R₁ is the inner radius of the pipe, I attenuated photon counts, Iₒ is the incident photon counts, and μ_{deposit} is the attenuation constant of the deposit.

For a given pipe system the ratio of attenuated photon counts to incident photo counts may be measured using any method discussed above.

For a given pipe system, the μ_{Water}, μᵢₙₛᵤₗₐₜᵢₒₙ, μ_{wall}, μₛₜᵣₑₐₘ, and μ_{deposit} values may be known or measured. In certain embodiments, the values may be measured using any conventional methods.

For a given pipe system, l_{Water}, lᵢₙₛᵤₗₐₜᵢₒₙ, and l_{wall} may be calculated using conventional methods. In certain embodiments, l_{Water}, lᵢₙₛᵤₗₐₜᵢₒₙ, and l_{wall} may be calculated using the following equation:

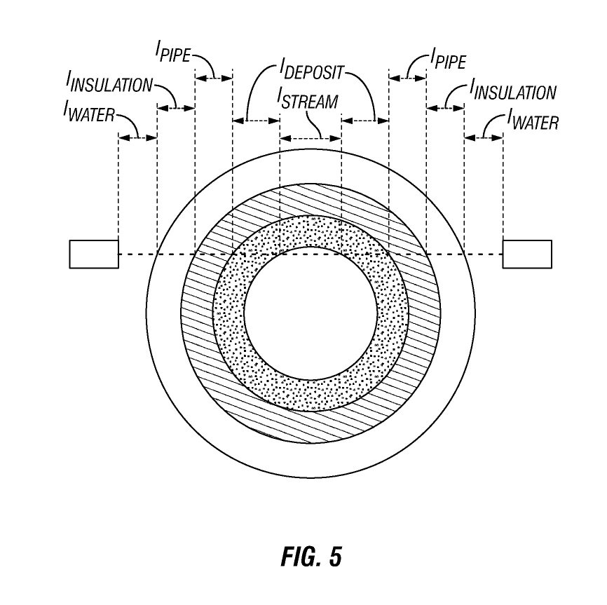

l=2[(R₁)Sin(a cos(h/R₁)−(R₂)Sin(60 cos(h/R₂)]

where, R₁ is the outer radius of the section, R₂ is the inner radius of the section, h is the distance from the center of the pipeline of the chord, and a is the angle of elevation of the detector/source. FIG. 5 illustrates the various lengths of the water, insulation, wall, stream, and deposit for a pipe system at a single chord. The various lengths of the water, insulation, wall, stream, and deposit may be added together to determine the total lengths of the water, insulation, wall, stream, and deposit along a single chord.

Once all of the variables have been provided, l_{deposit} may then be solved for at each position. The measured l_{deposit} values along each chord may then be compared to one another until the maximum value is found. The maximum l_{deposit} value represents the thickness of the deposit.

In other embodiments, the thickness of the deposit may be calculated by measuring the differences in counting periods of photons traversing a section of a pipe at different times. In such embodiments, the flow line may comprise two densitometers separated by at least the pipe diameter. Briefly, it has been discovered that if the counting periods are much shorter than the time for plugs and Taylor bubbles of the intermittent flow to pass the system beam, then different count rates will be measured for time periods during which the beam path inside the pipe traverses the plug sections and the Taylor bubble sections. By comparing the counting periods of photons traversing a section of pipe at different times a determination can be made on whether the photons traversed a plug section or a Taylor bubble section. Once such a determination has been made, the photon counts for each instance may be used to calculate the length of the stream utilizing the following equation:

$${l}_{stream} = \frac{ln ( {I}_{TaylorBubbleSegments} ) - ln ( {I}_{PlugSegments} )}{{μ}_{PlugSegment} - {μ}_{TaylorBubbleSegment}} ,$$

wherein, a multiphase flow model may be used to determine the average fluid composition of the Plug and Taylor Bubble sections, and to thereby determine the beam attenuation of each type of section. Additionally, the counting period at two separate locations of the flow line, wherein one location is a plug section and the other location is a Taylor bubble section, may be measured simultaneously using two densitometers. The length of the stream may then be calculated using the equation above.

Subtracting these path lengths from the beam path length inside of the pipe yields the deposit path length, from which the deposit thickness can be deduced.

To facilitate a better understanding of the present invention, the following examples of certain aspects of some embodiments are given. In no way should the following examples be read to limit, or define, the scope of the invention.

### EXAMPLES

### Example 1

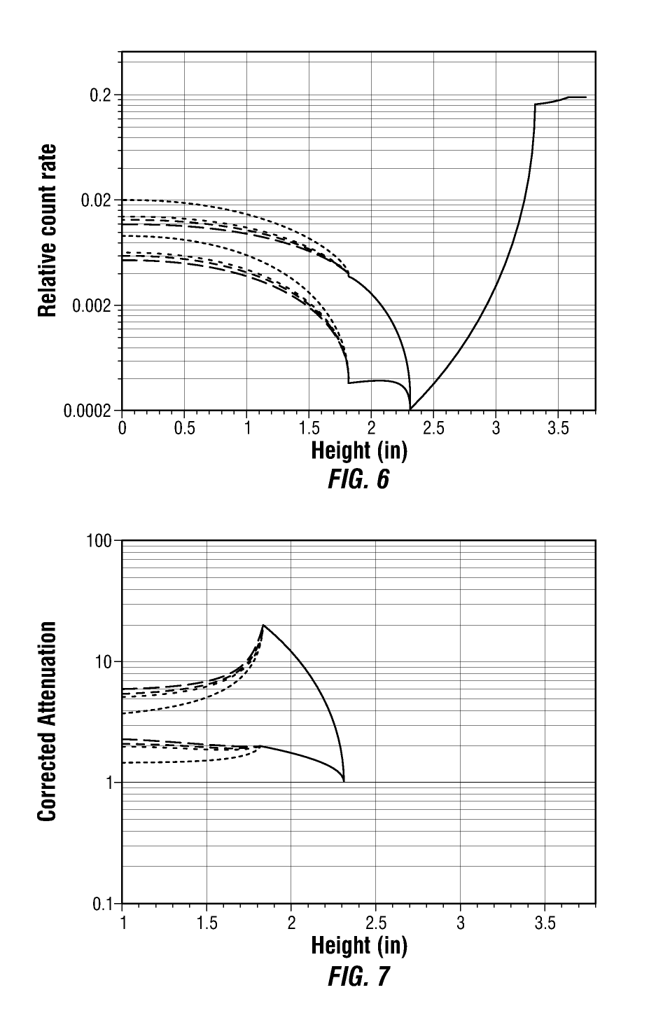

A first pipe have an inner diameter of 4.6 inches, an outer diameter of 6.6 inches, and 0.3 inches of coating was prepared with a wax deposit. A second pipe having an inner diameter of 4.6 inches, an outer diameter of 6.6 inches, and 0.3 inches of coating was prepared with a scale deposit. A mixture of oil and gas was flown through the first pipe and a second pipe. A densitometer comprising a source and a detector was placed on either side of each pipe and photon counts were measured at varying heights along an axis of each pipe. The relative counts of measured photons for each pipe were plotted on a chart. FIG. 6 illustrates the results of the chart. Analyzing the chart, by locating the local minimum and the convergence point, it was determined that the thickness of the deposits on either pipe were 0.5 inches.

### Example 2

In addition to the first pipe and second pipe in Example 1, a third pipe having an inner diameter of 4.6 inches, an outer diameter of 6.6 inches, and 0.3 inches of coating was prepared. The same mixture of oil and gas as the first pipe and the second pipe was flown through the third pipe. A densitometer comprising a source and a detector was placed on either side of the third pipe photon counts were measured at varying heights along an axis of each pipe. The relative counts of measured photons for the first and second pipes were each divided by the relative counts of measured photons of the third pipe to obtain corrected attenuation counts, and the corrected attenuation counts for the first and second each pipe were plotted on a chart. FIG. 7 illustrates the results of the chart. Analyzing the chart, by locating the local minimum and the convergence point, it was determined that the thickness of the deposits on either pipe were 0.5 inches.

### Example 3

The thickness of the deposit of each measured chord of the first and second pipe were calculate using the following equation:

$${l}_{deposit} = \frac{- ( \begin{matrix}{μ}_{Water} {l}_{Water} + {μ}_{insulation} {l}_{insulation} + \\ {μ}_{wall} {l}_{wall} + {μ}_{stream} R 1 + ln ( \frac{I}{{I}_{o}} )\end{matrix} )}{{μ}_{deposit} - {μ}_{stream}} .$$

For both the first and second pipes, the μ_{Water}, μᵢₙₛᵤₗₐₜᵢₒₙ, μ_{wall}, μₛₜᵣₑₐₘ, and μ_{deposit} values were obtained. The l_{Water} value, the lᵢₙₛᵤₗₐₜᵢₒₙ value, and the l_{wall} value were calculated at each chord using the following equation:

l=2[(R₁)Sin(a cos(h/R₁)−(R₂)Sin(a cos(h/R₂)]

Once each a l_{deposit} value was calculated for each chord length, it was determined that the maximum l_{deposit} value was 0.5 inches for the first pipe and the second pipe.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A method of measuring a flow line deposit comprising:
providing a pipe comprising the flow line deposit; measuring unattenuated photon counts across the pipe; and analyzing the measured unattenuated photon counts to determine the thickness of the flow line deposit.

2. The method of claim 1, wherein measuring unattenuated photon counts across the pipe comprises generating incident photon counts on a first side of the pipe and detecting unattenuated photon counts on a second side of the pipe.

3. The method of claim 2, wherein the generated incident photon counts are generated by an X-ray or gamma ray source.

4. The method of claim 1, wherein a densitometer is used for measuring the unattenuated photon counts across the pipe.

5. The method of claim 4, wherein the densitometer comprises a source and a detector array.

6. The method of claim 5, wherein the source and the detector array are in a parallel beam arrangement or a fan beam arrangement.

7. The method of claim 1, wherein measuring unattenuated photon counts across the pipe comprises measuring unattenuated photon counts along multiple chords.

8. The method of claim 1, wherein analyzing the measured unattenuated photon counts comprises generating a plot of the measured unattenuated photon counts and analyzing the plot to determine the thickness of the flow line deposit.

9. The method of claim 1, wherein analyzing the measured unattenuated photon counts comprises generating a plot of corrected attenuation counts and analyzing the plot to determine the thickness of the flow line deposit.

10. A method of measuring a flow line deposit comprising:
providing a pipe comprising the flow line deposit; measuring unattenuated photon counts across the pipe; and calculating the thickness of the flow line deposit.

11. The method of claim 10, wherein measuring unattenuated photon counts across the pipe comprises generating incident photon counts on a first side of the pipe and detecting unattenuated photon counts on a second side of the pipe.

12. The method of claim 11, wherein the generated incident photon counts are generated by an X-ray or gamma ray source.

13. The method of claim 10, wherein a densitometer is used for measuring the unattenuated photon counts across the pipe.

14. The method of claim 13, wherein the densitometer comprises a source and a detector array.

15. The method of claim 14, wherein the source and the detector array are in a parallel beam arrangement or a fan beam arrangement.

16. The method of claim 10, wherein measuring unattenuated photon counts across the pipe comprises measuring unattenuated photon counts along multiple chords.

17. The method of claim 10, wherein calculating the thickness of the flow line deposit comprises using an equation to calculate the thickness.

18. The method of claim 10, wherein measuring unattenuated photon counts across the pipe comprises measuring unattenuated photon counts traversing a section of a pipe at different times.

19. The method of claim 10, wherein measuring unattenuated photon counts across the pipe comprises measuring unattenuated photon counts at different sections of the pipe simultaneously.

20. A system comprising: a flow line comprising a flow line deposit and a densitometer, wherein the densitometer comprises a source and a detector array in a parallel beam arrangement or a fan beam arrangement.
